(19) United States
(12) Patent Application Publication
(10) Pub. No.: US 2004/0232115 A1
(43) Pub. Date: Nov. 25, 2004

(54) SOAs in series

(76) Inventor: Richard Stoltz, Plano, TX (US)

Correspondence Address: CHALKER FLORES, LLP, 12700 PARK CENTRAL, STE. 455, DALLAS, TX, 75251, US

(21) Appl. No.: 10/850,326

(22) Filed: May 19, 2004

Related U.S. Application Data
(60) Provisional application No. 60/472,070, filed on May 20, 2003.
(60) Provisional application No. 60/471,913, filed on May 20, 2003.

(51) Int. Cl. H01S 3/10; B23K 26/00

(52) U.S. Cl. 219/121.6

(57) ABSTRACT

The present invention relates to a system and method of laser ablation by connecting two or more semiconductor optical amplifier diodes electrically and optically in series, wherein one of the diodes is an optically-first diode and another of the diodes is an optically-last diode, introducing current into the series diodes; introducing at least two optical signal input pulses into the optically-first of the series diodes; amplifying and coupling the optical signal pulses out of the last optical diode, time-compressing the amplified pulses and directing the compressed pulses toward a work-piece with a pulse-energy-density of 0.1 to 20 Joules/square centimeter.

### CROSS-REFERENCE TO RELATED APPLICATIONS

This application claims priority to United States Provisional Patent Applications: entitled, “SOAs Electrically And Optically In Series,” Ser. No. 60/471,913 (Docket No. ABI-3) and entitled “Laser Contact With W/Dopant/Copper-Alloy,” Ser. No. 60/472,070 (Docket No. ABI-2); both filed May 20, 2003.

### TECHNICAL FIELD OF THE INVENTION

The present invention relates to semiconductor optical amplifier diodes (SOAs), and more particularly, to SOAs that are electrically and optically in series during laser ablation.

### BACKGROUND OF THE INVENTION

Laser machining is most efficiently done with a beam of very short pulses (generally a pulse-duration of three picoseconds or less). While most laser machining melts portions of the work-piece, this type of machining is ablative, disassociating the surface atoms. Techniques for generating these ultra-short pulses are described, e.g., in a book entitled “Femtosecond Laser Pulses” (C. Rulliere—editor), published 1998, Springer-Verlag Berlin Heidelberg N.Y. Generally, large systems, e.g., Ti:Sapphire lasers, have been used for generating ultra-short pulses (USP).

USP phenomenon was first observed in the 1970's, when it was discovered that mode-locking a broad-spectrum laser could produce USP's. The minimum pulse duration attainable is limited by the bandwidth of the gain medium, which is inversely proportional to this minimal or Fourier-transform-limited pulse duration. Mode-locked pulses are typically very short and will spread (i.e., undergo temporal dispersion) as they traverse any medium. Subsequent pulse-compression techniques are often used to obtain USP's. Pulse dispersion can occur within the laser cavity so that compression techniques are sometimes added intra-cavity. When high-power pulses are desired, they are intentionally lengthened before amplification to avoid internal component optical damage. This is referred to as “Chirped Pulse Amplification” (CPA). The pulse is subsequently compressed to obtain a high peak power (pulse-energy amplification and pulse-duration compression).

### SUMMARY OF THE INVENTION

The present invention relates to semiconductor optical amplifier diodes (SOAs) that are electrically and optically in series during laser ablation. For example, laser machining is most efficiently done with a beam of very short pulses (generally a pulse-duration of three picoseconds or less). This type of machining is ablative, disassociating the surface atoms, but requires very high energy densities and even with time-compression of amplified pulses, thousands of amps can be required. By connecting at least three semiconductor optical amplifier diodes (SOAs) electrically and optically in series, optical power generated in each of the series diodes is essentially the same and all the optically generated power exits from a single diode, and problems of combining output from multiple optically-parallel diodes are avoided.

Further, by using SOAs electrically in series, the current is substantially reduced from the current required to obtain the needed ablation-level optical power from a single diode (e.g., from over one-thousand amps to about 100 amps) or from more than one diode in series. Using a number (generally at least three, and in some embodiments at least ten) of diodes electrically in series reduces currents by approximately the number of diodes and greatly reduces 12 R losses. An optical pulse signal can be introduced into the optically-first of the series diodes, where the optical pulse signal include light having a wavelength that either increases or decreases with time, and wherein the optical pulse signal is at least 100 picoseconds. The optical pulse signal can then be amplified to an energy of at least one micro-Joule and coupled out of the optically-last diode and time-compressed to a pulse-duration of 50 femtoseconds to three picoseconds. In some embodiments, the series diodes are on a single semiconductor chip.

More particularly, by connecting at least two (and preferably at least three) semiconductor optical amplifier diodes (SOAs) electrically and optically in series, optical power generated in each of the series diodes is essentially the same and the optically generated power exits from a single diode, and problems of combining output from multiple optically-parallel diodes (e.g., optical interference and optical losses in star connectors) are avoided. Further, by using SOAs electrically in series, the current is substantially reduced from the current required to obtain ablation-level optical power from a single diode (e.g., from over one-thousand amps to about 100 amps). Using a number (generally at least 3, and preferably at least 10) of diodes electrically in series reduces currents by approximately the number of diodes and reduces I²R losses including power supply losses).

The present invention is a method of laser ablation, that includes the steps of: connecting at least three semiconductor optical amplifier diodes electrically and optically in series, wherein one of the diodes is an optically-first diode and another of the diodes is an optically-last diode; introducing current into the series diodes; introducing an at least two pulse optical signal into the optically-first of the series diodes; amplifying the optical signal and coupling the amplified optical signal out of the optically-last diode; time-compressing the amplified pulses to a pulse-duration of 50 femtoseconds to three picoseconds; and directing a beam of the compressed pulses having to a work-piece with a pulse-energy-density of 0.1 to 20 Joules/square centimeter. The work-piece can, in some embodiments be air, such that an ionized path through the air is created.

In some embodiments, the series diodes are on a single semiconductor chip. Preferably, at least one-thousand pulses per second are generated, and more preferably at least one-hundred-thousand pulses per second are generated. The compressed-pulse-duration is preferably 50 femtoseconds to 1 picosecond and in many embodiments, the pulse-energy-density is preferably between 0.1 and 8 Joules/square centimeter on the work-piece. The ablation can be part of a surgical procedure, and when the pulses are used as part of a surgical procedure, the pulses preferably contain less than 10 micro-Joules per pulse.

Alternatively, the present invention may be a method of generating an optical pulse, comprising: connecting at least two semiconductor optical amplifier diodes electrically and optically in series, wherein one of the diodes is an optically-first diode and another of the diodes is an optically-last diode; introducing current into the series diodes; introducing at least one optical pulse signal into the optically-first of the series diodes, wherein the optical pulse signal comprises light having a wavelength that either increases or decreases with time, and wherein the optical pulse signal is at least 100 picoseconds; amplifying the optical pulse signal to an energy of at least one (1) micro-Joule and coupling the amplified optical signal out of the optically-last diode; and time-compressing the amplified pulse to a pulse-duration of 50 femtoseconds to three picoseconds. For example, a 100 femtosecond pulse can be time-stretched to make an optical pulse signal ramp (of, e.g., increasing, wavelength) which is amplified (at comparatively low instantaneous power), and time-compressed into an amplified 100 femtosecond pulse. Generally a series of pulses are generated, and thus a series of wavelength-ramps are used (e.g., a “saw-tooth” waveform with 50 “teeth” is preferably amplified by the SOAs without turning the current off between the teeth). Thus, although the amplifiers are amplifying continuously during the 50-tooth waveform, the time-compression will separate the optical output into 50 separate pulses.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Laser machining is most efficiently done with an ablative-energy-level beam of very short pulses (generally a pulse-duration of three picoseconds or less), and even with time-compression of amplified pulses, thousands of amps can be required. By connecting at least three semiconductor optical amplifier diodes (SOAs) electrically and optically in series, optical power generated in each of the series diodes is essentially the same and the optically generated power exits from a single diode, and problems of combining output from multiple optically-parallel diodes are avoided.

Further, by using SOAs electrically in series, the current is substantially reduced from the current required to obtain ablation-level optical power from a single diode (e.g., the use of ten SOAs can reduce current from over one-thousand amps to about 100 amps). Using a number of diodes electrically in series (preferably at least three (3), and more preferably at least ten (10)) reduces currents by approximately the number of diodes and greatly reduces I²R losses (by approximately the number of diodes squared). Use of the method of the present invention allows currents of preferably less than 200 amps to be used for ablation, greatly reduces equipment costs, and enables portable ablative equipment. As the total light output exits the final diode, it can be efficiently coupled into an optical fiber.

For example, for surgical applications, a 20 micron spot can be appropriate. For a 1 micro-Joule pulse from, e.g., 9 SOAs, this might give about 0.33 Joules/square centimeter into the optical delivery system. If the optical delivery system is less than about 50% efficient, more pulse energy will be probably needed from the SOAs.

If one used multiple optically-parallel SOAs to generate a single spot, it would require combining the optical outputs. The major problems in combining optical outputs are optical interference and efficiency. While star connectors could be used join optical fibers from multiple SOAs and combine their optical energy, for 9 fibers, this generally needs multiple star connectors, e.g., 3 sets of 3-to-1 star connectors feeding into an output 3-to-1 star connector. Star connectors, however, have generally been of low (e.g., 50%) efficiency, and more SOAs and more star connectors would generally be needed. A hybrid approach might be 3 sets of 3 SOAs in optical series joined by a 3-to-1 star connector. While low efficiencies can be tolerated in signal-level (e.g., milliwatt) applications, such low efficiencies dramatically increase costs in power-level (e.g., multi-watt) systems.

The most efficient optical delivery system uses SOAs optically in series and delivers the output into a single fiber. The last SOA is designed and/or sized to handle the full SOA optical output energy. Efficiency in coupling between SOAs, e.g., with good anti-reflection (A/R) techniques, is important and preferably there are multiple SOAs on a chip. Multi-contact chips (e.g., chips having more than one set of top and bottom contacts to allow the diodes to be electrically in series) allow wafer-type manufacturing of the optical coupling between SOAs.

While using a multiple-diode chip (chips having more than one set of top and bottom contacts) having the diodes electrically and optically in series, can greatly reduce I²R losses and allow light to be efficiently coupled between diodes. As there is a voltage between adjacent contacts (both top and bottom) on the chip and close spacing of contacts can cause excessive leakage currents. Thus, as such adjacent contacts have different voltages, isolation of adjacent top contacts and adjacent bottom contacts does need to be addressed, e.g., by controlling spacings and material properties with or without replacing waveguide material.

In some embodiments, electrically-isolating (and optically-conducting materials in between top contacts, e.g., either amorphous by evaporation or polycrystalline by sputtering, including etching trenches through a quantum-well (QW) layer in the waveguide area and back filling with GaAs) are used to minimize current leakage. The semiconducting crystalline semiconductor material can also be turned into insulating amorphous material by ion implantation. While such isolation could be done on both the top and bottom contacts, the layers above the active region (typically a quantum well) are thin (generally on the order of a few microns or less) and especially if an anti-reflective (A/R) grating is used between contacts, the resistance between adjacent top contacts is high and further isolation may not be necessary (however, ion implantation may be done on the top side for other purposes and, if so, can be done for electrical isolation as well).

Isolation of adjacent bottom contacts (with different voltages) can be provided as noted above, and thinning of the substrate will reduce leakage current. If isolated adjacent bottom contacts are desired patterned photoresist can be used with etching or rejection of metal to prevent bridging of metal between contacts. Countersunk bottom contacts can also be used, especially with sidewall insulation and coefficient of thermal expansion matching metals such as tungsten-copper or molybdenum-copper to both reduce series resistance of the SOAs and reduce current between adjacent bottom contacts. The use of an etch stop (e.g., aluminum gallium arsenide with a gallium arsenide substrate) as the first epitaxially deposited layer can allow metal-to-active-layer distances similar to those on the top contact.

The method of the present invention provides for the use of novel metal contacts, e.g., on the top and bottom surfaces of a GaAs laser diode and may include tungsten. The tungsten provides a metallurgically stable surface in contact with the semiconductor, which has a thermal expansion closely matched to the semiconductor and also provides a barrier that controls diffusion of dopant into the semiconductor. Generally, a relatively thick layer of copper alloyed with tungsten and/or molybdenum which has a thermal expansion very closely matched to the semiconductor provides the outer layer. Thus, there is molybdenum-copper or tungsten-copper or molybdenum-tungsten-copper on a dopant layer, that is on the tungsten, that is on the semiconductor. This tungsten metal contact system may be used on the top contact, the bottom contact, or both. The dopant is of the same type as the adjacent semiconductor.

Preferably, the electrode material is highly-doped semiconductor and has a metal contact on the outer surface. In one preferred embodiment, the metal directly on the highly-doped semiconductor is tungsten deposited by CVD (preferably using hydrogen reduction from tungsten hexafluoride). The CVD deposition of tungsten is described in U.S. Pat. No. 3,798,060 “Methods for fabricating ceramic circuit boards with conductive through holes” by Reed and Stoltz. Molybdenum-copper or tungsten-copper or molybdenum-tungsten-copper can be used as copper alloys over the dopant. The dopant is on the tungsten that is on the semiconductor. This tungsten metal contact system may be used on the top contact, the bottom contact, or both.

Countersunk bottom contacts can also be used, especially coefficient of thermal expansion matching metals such as tungsten-copper or molybdenum-copper to both reduce series resistance of the SOAs and reduce current between adjacent bottom contacts. The use of an etch stop (e.g., aluminum gallium arsenide with a gallium arsenide substrate) as the first epitaxially deposited layer can allow metal to active layer distances similar to on the top contact. Isolation of adjacent bottom contacts (with different voltages) can be provided by countersunk bottom contacts, especially with sidewall insulation.

Countersunk bottom contacts can be fabricated by patterning and the bottom of the wafer down to the first epitaxially deposited etch stop layer (a support wafer can be temporarily attached to the top) and a conformal insulation layer applied. A directional etch can then remove the insulation to exposed the etch stop layer, and then the tungsten and dopant applied as above. The tungsten-copper or molybdenum-copper is then deposited to be at least above even with the bottom of the substrate.

The present inventions include an improved method of making a semiconductor laser diode on a semiconductor substrate, the steps of providing a semiconductor having epitaxially grown layers adjacent a top semiconductor surface and a bottom semiconductor surface; providing a bottom metal contact on at least a portion of the bottom semiconductor surface wherein the bottom contact has a tungsten metal layer adjacent the bottom semiconductor surface, and a dopant layer over the tungsten metal, and with a copper alloy layer of molybdenum-copper or tungsten-copper or molybdenum-tungsten-copper over the dopant layer; and diffusing at least a portion of the dopant layer through the tungsten metal in the semiconductor. In some embodiments, the bottom metal contact is countersunk into the substrate.

Another improved method of making a semiconductor laser diode, the steps of providing a semiconductor having a top semiconductor surface and a bottom semiconductor surface; providing a top metal contact on at least a portion of the top semiconductor surface, wherein the top contact has a layer adjacent the top semiconductor surface is of tungsten metal, and a dopant layer over the tungsten metal, and with a copper alloy layer of molybdenum-copper or tungsten-copper or molybdenum-tungsten-copper over the dopant layer; and diffusing at least a portion of the dopant layer through the tungsten metal in the semiconductor.

These improved contacts reduce voltage, reduce I²R losses, and increase efficiency. When connecting diodes electrically in series, such contacts even further improve performance. Note coupling light in at a small angle may be desirable and thus the contact centerlines may not be aligned.

Information of such a system and other information on ablation systems are given in co-pending provisional applications listed in the following paragraphs (which are also at least partially co-owned by, or exclusively licensed to, the owners hereof) and are hereby incorporated by reference herein (provisional applications listed by docket number, title and provisional number).

Docket number ABI-1 Laser Machining—provisional application Ser. No. 60/471,922; ABI-4 “Camera Containing Medical Tool,” Ser. No. 60/472,071; ABI-6 “Scanned Small Spot Ablation With A High-Rep-Rate,” Ser. No. 60/471,972; and ABI-7 “Stretched Optical Pulse Amplification and Compression,” Ser. No. 60/471,971, were filed May 20, 2003.

ABI-8 “Controlling Repetition Rate Of Fiber Amplifier,”—Ser. No. 60/494,102; ABI-9 “Controlling Pulse Energy Of A Fiber Amplifier By Controlling Pump Diode Current,” Ser. No. 60/494,274; ABI-11 “Ablative Material Removal With A Preset Removal Rate or Volume or Depth,” Ser. No. 60/494,273; ABI-12 “Fiber Amplifier With A Time Between Pulses Of A Fraction Of The Storage Lifetime,” Ser. No. 60/494,272; ABI-13 “Man-Portable Optical Ablation System,” Ser. No. 60/494,321; ABI-14 “Controlling Temperature Of A Fiber Amplifier By Controlling Pump Diode Current,” Ser. No. 60/494,322; ABI-15 “Altering The Emission Of An Ablation Beam for Safety or Control,” Ser. No. 60/494,267; ABI-16 “Enabling Or Blocking The Emission Of An Ablation Beam Based On Color Of Target Area,” Ser. No. 60/494,172; ABI-17 “Remotely-Controlled Ablation of Surfaces,” Ser. No. 60/494,276 and ABI-18 “Ablation Of A Custom Shaped Area,” Ser. No. 60/494,180; were filed Aug. 11, 2003; ABI-19 “High-Power-Optical-Amplifier Using A Number Of Spaced, Thin Slabs,” Ser. No. 60/497,404 was filed Aug. 22, 2003.

Co-owned ABI-20 “Spiral-Laser On-A-Disc,” Ser. No. 60/502,879; and partially co-owned ABI-21 “Laser Beam Propagation in Air,” Ser. No. 60/502,886 were filed on Sep. 12, 2003.

ABI-22 “Active Optical Compressor,” Ser. No. 60/503,659 and ABI-23 “Controlling Optically-Pumped Optical Pulse Amplifiers,” Ser. No. 60/503,578 were both filed Sep. 17, 2003.

ABI-24 “High Power SuperMode Laser Amplifier,” Ser. No. 60/505,968 was filed Sep. 25, 2003, ABI-25 “Semiconductor Manufacturing Using Optical Ablation,” Ser. No. 60/508,136 was filed Oct. 2, 2003, ABI-26 “Composite Cutting With Optical Ablation Technique,” Ser. No. 60/510,855 was filed Oct. 14, 2003 and ABI-27 “Material Composition Analysis Using Optical Ablation,” Ser. No. 60/512,807 was filed Oct. 20, 2003.

ABI-28 “Quasi-Continuous Current in Optical Pulse Amplifier Systems,” Ser. No. 60/529,425 and ABI-29 “Optical Pulse Stretching and Compressing,” Ser. No. 60/529,443, were both filed Dec. 12, 2003.

ABI-30 “Start-up Timing for Optical Ablation System,” Ser. No. 60/539,026; ABI-31 “High-Frequency Ring Oscillator,” Ser. No. 60/539,024; and ABI-32 “Amplifying of High Energy Laser Pulses,” Ser. No. 60/539,025; were filed Jan. 23, 2004.

ABI-33 “Semiconductor-Type Processing for Solid-State Lasers,” Ser. No. 60/543,086, was filed Feb. 9, 2004; and ABI-34 “Pulse Streaming of Optically-Pumped Amplifiers,” Ser. No. 60/546,065, was filed Feb. 18, 2004. ABI-35 “Pumping of Optically-Pumped Amplifiers,” was filed Feb. 26, 2004.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of laser ablation comprising the steps of:
connecting at least three semiconductor optical amplifier diodes electrically and optically in series, wherein one of the diodes is an optically-first diode and another of the diodes is an optically-last diode;
introducing current into the series diodes;
introducing at least two optical signal input pulses into the optically-first of the series diodes;
amplifying the optical signal pulses and coupling the amplified optical signal out of the optically-last diode;
time-compressing the amplified pulses to a pulse-duration of 50 femtoseconds to three picoseconds; and
directing a beam of the compressed pulses having to a work-piece with a pulse-energy-density of 0.1 to 20 Joules/square centimeter, whereby optical power generated in each of the series diodes is essentially the same and the optically generated power exits from a single diode, and the current is substantially reduced from the current required to obtain that optical power from a single diode.

2. The method of claim 1, wherein at least one-thousand pulses per second are generated.

3. The method of claim 1, wherein at least one-hundred-thousand pulses per second are generated.

4. The method of claim 1, wherein the compressed-pulse-duration is 50 femtoseconds to 1 picosecond.

5. The method of claim 1, wherein the series diodes are on a single semiconductor chip.

6. The method of claim 1, wherein the pulse-energy-density is between 0.1 and 8 Joules/square centimeter on the work-piece.

7. The method of claim 1, wherein the ablation is part of a surgical procedure.

8. A method of generating an optical pulse, comprising:
connecting at least two semiconductor optical amplifier diodes electrically and optically in series, wherein one of the diodes is an optically-first diode and another of the diodes is an optically-last diode;
introducing current into the series diodes;
introducing at least one optical pulse signal into the optically-first of the series diodes, wherein the optical pulse signal comprises light having a wavelength that either increases or decreases with time, and wherein the optical pulse signal is at least 100 picoseconds;
amplifying the optical pulse signal to an energy of at least 1 micro-Joule and coupling the amplified optical signal out of the optically-last diode; and
time-compressing the amplified pulse to a pulse-duration of 50 femtoseconds to three picoseconds.

9. The method of claim 8, wherein the series diodes are on a single semiconductor chip.

10. The method of claim 8, wherein the pulses are used as part of a surgical procedure.

11. The method of claim 10, wherein the pulses contain less than 10 micro-Joules per pulse.

12. The method of claim 8, wherein countersunk bottom contacts are used.

13. The method of claim 10, wherein the amplified pulse comprises a pulse-energy-density of between about 0.1 and about 8 Joules/square centimeter.

14. The method of claim 1, wherein at least one-thousand pulses per second are generated.

15. The method of claim 10, wherein at least ten-thousand pulses per second are generated.

16. The method of claim 10, wherein the compressed-pulse-duration is 50 femtoseconds to 1 picosecond.
